(19) United States
(12) Patent Application Publication
(10) Pub. No.: US 2008/0225985 A1
(43) Pub. Date: Sep. 18, 2008

(54) Method and Apparatus for Enhancing GSM System Capacity

(76) Inventors: Shiquan (Robert) Wu, Ottawa (CA); Jim Wight, Ottawa (CA); Shiwei Gao, Nepean (CA)

Correspondence Address: Anderson Gorecki & Manaras LLP, 33 NAGOG PARK, ACTON, MA, 01720, US

(21) Appl. No.: 11/685,341

(22) Filed: Mar. 13, 2007

(51) Int. Cl. H04L 27/12

(52) U.S. Cl. 375/308; 370/347

(57) ABSTRACT

There is provided a system and method of enhancing capacity of a wireless communication channel compromising the steps of modulating data in accordance with first modulation scheme transforming the modulated data from a frequency domain symbol to a time domain version and encoding bits in a wireless communication timeslot independence upon the time domain version whereby capacity of the wireless communication channel is enhanced. The system and method further comprises the steps of: means for receiving the timeslot means for decoding the timeslot and means for transforming the decoded bits from time domain to frequency domain to recover the data. GSM capacity is enhanced between two and six times.

### FIELD OF THE INVENTION

The present invention relates to methods and apparatuses for global system for mobile communication (GSM) and is particularly concerned with enhancing capacity.

### BACKGROUND OF THE INVENTION

GSM (Global System for Mobile Communications) is a world wide dominant wireless cellular communications system. It is a FDD-TDMA (Frequency Division-Duplex-Time-Division-Multiplex-Access) system, each carrier occupying 200 kHz which is time shared by eight time slots or users. A typical example of the frequency channels and time slots is shown in FIG. 1.

The GSM slot structure for different types of slots (also called bursts) is illustrated in FIG. 2 (Refer to 3GPP TS 05.02). There are five types of bursts: (1) a Normal burst to carry data and control information, (2) a Frequency correction burst used by a terminal for acquiring base station frequency information, (3) a synchronization burst used by a terminal to find downlink timing, (4) an Access burst used by a terminal for random access and handover access, and (5) a Dummy burst used for rate adaptation and matching purposes. For each burst/slot, a total of 156.25 bits are transmitted in 0.577 milliseconds, giving a gross bit rate of 270.833 kbps. In each normal burst/slot, 26 bit training sequence in the middle are used for channel tracking, 3 tail bits (TB) on both ends are used for reset the Viterbi equalizer state in a receiver, and the last 8.25 bits guard time allows power ramp up and down and for some propagation time delay in the arrival of bursts to ensure that the slots do not collide with each other.

The frames and slots numerology are illustrated in FIG. 3. Each group of eight time slots is called a TDMA frame, which is transmitted every 4.615 ms. TDMA frames are further grouped into multiframes to carry control signals. There are two types of multiframe, containing either 26 or 51 TDMA frames. The 26 frame multiframe contains 24 Traffic Channels (TCH) and two Slow Associated Control Channels (SACCH) which supervise each call in progress. The SACCH in frame 12 contains eight channels, one for each of the eight connections carried by the TCHs. The SACCH in frame 25 is not currently used, but will carry eight additional SACCH channels when half rate traffic is implemented. A Fast Associated Control Channel (FACCH) works by stealing slots from a traffic channel to transmit power control and handover signalling messages. The channel stealing is done by setting one of the control bits in the burst.

In addition to the Associated Control Channels, there are several other control channels which (except for the Standalone Dedicated Control Channel) are implemented in time slot 0 of specified TDMA frames in a 51 frame multiframe, implemented on a non-hopping carrier frequency in each cell.

Full Rate Spread Coding: GSM is a digital system, so speech signals, inherently analog, have to be digitized. The GSM group studied several voice coding algorithms on the basis of subjective speech quality and complexity (which is related to cost, processing delay, and power consumption once implemented) before arriving at the choice of a Regular Pulse Excited—Linear Predictive Coder (RPELPC) with a Long Term Predictor loop. In practice, information from previous samples, which do not change very quickly, is used to predict the current sample. The coefficients of the linear combination of the previous samples, plus an encoded form of the residual (the difference between the predicted and actual sample), represent the signal. Speech is divided into 20 millisecond samples, each of which is encoded as 260 bits, giving a total bit rate of 13 kbps.

Recall that the speech codec produces a 260 bit block for every 20 ms speech sample. From subjective testing, it was found that some bits of this block were more important for perceived speech quality than others. The bits are thus divided into three classes:

Class Ia 50 bits—most sensitive to bit errors

Class Ib 132 bits—moderately sensitive to bit errors

Class II 78 bits—least sensitive to bit errors

Class Ia bits have a three-bit Cyclic Redundancy Code added for error detection. If an error is detected in the receiver, the frame is judged too damaged to be comprehensible and it is discarded. It is then replaced by a slightly attenuated version of the previous correctly received frame. These 53 bits, together with the 132 Class Ib bits and a four-bit tail sequence (a total of 189 bits), are input into a ½ rate convolutional encoder of constraint length four. Each input bit is encoded as two output bits, based on a combination of the previous four input bits. The convolutional encoder thus outputs 378 bits, to which are added the 78 remaining Class II bits, which are unprotected. Thus every 20 ms speech sample is encoded as 456 bits, giving a bit rate of 22.8 kbps. FIG. 4 further illustrates how this process is implemented.

To further protect against the burst errors common to the radio interface, the 456 bits output from the convolutional encoder are interleaved and then divided into eight blocks of 57 bits (refer to 3GPP TS 05.03), and these blocks are transmitted in eight consecutive timeslot bursts. Since each timeslot burst can carry two 57 bit blocks, each burst carries traffic from two successive speech blocks of 20 ms each. FIG. 5 illustrates this interleaving process in detail.

Each timeslot burst is transmitted at a gross bit rate of 270.833 kbps. The modulating symbol rate is 1/T=1,625/6 ksymbols/s (i.e. approximately 270.833 ksymbols/s). This digital signal is modulated onto the analog carrier frequency, which has a channel bandwidth of 200 kHz, using Gaussian Filtered Minimum Shift Keying (GMSK).

GMSK Modulation Start and Stop of the Burst (Refer GSM 05.04 V.8.1.0 Release 1999). Before the first bit of the burst, as defined in GSM 05.02 [3], enters the modulator, the modulator has an internal state as if a modulating bit stream consisting of consecutive ones (di=1) had entered the differential encoder. Also after the last bit of the time slot, the modulator has an internal state as if a modulating bit stream consisting of consecutive ones (di=1) had continued to enter the differential encoder. These bits are called dummy bits and define the start and the stop of the active and the useful part of the burst. Nothing is specified about the actual phase of the modulator output signal outside the useful part of the burst.

FIG. 6 shows the relationship between active part of burst, tail bits and dummy bits. For the normal burst, the useful part lasts for 147 modulating bits.

8-PSK Modulation: 8-PSK was introduced in Enhanced Data Rates for global Evolution (EDGE) to increase the data rate of the GSM network (Refer to 3GPP TS 05.04). Each symbol carries 3 bits as compared to GMSK which carries only 1 bit. The modulating bits are Gray mapped in groups of 3 bits to a 8-PSK symbol by the following rule.

sᵢ=e^{j2πl/8}

where l is given in the following table

TABLE1
Mapping between the modulating bits and the 8PSK
symbol parameter l.

| Modulating bits d₃ᵢ,, | |
|---|---|
| d₃ᵢ₊₁, d₃ᵢ₊₂ | Symbol parameter l |
| (1, 1, 1) | 0 |
| (0, 1, 1) | 1 |
| (0, 1, 0) | 2 |
| (0, 0, 0) | 3 |
| (0, 0, 1) | 4 |
| (1, 0, 1) | 5 |
| (1, 0, 0) | 6 |
| (1, 1, 0) | 7 |

This is illustrated in the FIG. 7.

Start and stop of a burst (refer to 3GPP TS 05.04, 1998): As each symbol carries 3 bits, the start and stop of each burst needs to be modified accordingly. Before the first bit of the bursts as defined in GSM 05.02 [3] enters the modulator, the state of the modulator is undefined. Also after the last bit of the burst, the state of the modulator is undefined. The tail bits (see GSM 05.02) define the start and the stop of the active and the useful part of the burst as illustrated in FIG. 8. Nothing is specified about the actual phase of the modulator output signal outside the useful part of the burst.

Symbol Rotation:

The 8PSK symbols are continuously rotated with 3π/8 radians per symbol before pulse shaping. The rotated symbols are defined as

ŝᵢ=sᵢ·e^{ji3π/8}

Pulse Shaping:

The modulating 8PSK symbols ŝᵢ as represented by Dirac pulses, excite a linear pulse shaping filter. This filter is a linearised GMSK pulse, i.e. the main component in a Laurant decomposition of the GMSK modulation. The impulse response is defined by:

$${c}_{0} ( t ) = \{ \begin{matrix}{\prod }_{i = 0}^{3} S ( t \vert iT ) , & for 0 \leq t \leq 5 T \\ 0 , & else\end{matrix} \\ where \\ S ( t ) = \{ \begin{matrix}sin ( π {\int }_{0}^{t} g ( {t}^{′} ) d {t}^{′} ) & for 0 \leq t \leq 4 T \\ sin ( \frac{π}{2} - π {\int }_{0}^{4 {T}_{s}} g ( {t}^{′} ) d {t}^{′} ) , & for 4 T < t \leq 8 T \\ 0 , & else\end{matrix} \\ g ( t ) = \frac{1}{2 {T}_{s}} ( Q ( 2 π \cdot 0.3 \frac{t - 5 T / 2}{T \sqrt{{log}_{e} ( 2 )}} ) - Q ( 2 π \cdot 0.3 \frac{t - 3 T / 2}{T \sqrt{{log}_{e} ( 2 )}} ) ) \\ and \\ Q ( t ) = \frac{1}{\sqrt{2 π}} {\int }_{t}^{∞} {e}^{- \frac{{τ}^{2}}{2}} d τ .$$

The base band signal is

$$y ( {t}^{′} ) = {\sum }_{i} {\hat{s}}_{i} \cdot {c}_{0} ( {t}^{′} - iT + \frac{5}{2} T )$$

The time reference t′=0 is the start of the active part of the burst as shown in FIG. 2 This is also the start of the bit period of bit number 0 (the first tail bit) as defined in GSM 05.02 [2].

Orthorgonal Multicarrier Modulation is a modulation format in which a group of sub-carriers are each individually QAM (Quadrature Amplitude Modulation) modulated using a group of data bits and all the subcarriers are mutually orthogonal in terms of the discreet Fourier transform (DFT). An example of an orthogonal multicarrier system is the IEEE 802.11a Standard, in which 48 of 64 sub-carriers are modulated with one of the following modulation formats; QPSK (Quadrature Phase Shift Keying), 16 QAM, or 64 QAM. With QPSK, each sub-carrier conveys two data bits; with 16 QAM, each sub-carrier conveys four data bits; and with 64 QAM, each sub-carrier conveys six data bits as shown in FIG. 9.

With modern DSP (Digital Signal Processing), it is possible to construct a sampled time version of one symbol duration, by representing the QAM modulated sub-carriers as complex numbers, and performing an IDFT (Inverse Discrete Fourier Transform). With N sub-carriers, N time samples equally spaced throughout the symbol duration are obtained, as shown in FIG. 10. This process is repeated for each successive symbol.

In a multi-path environment, several replicas of each transmitted symbol are received by the receiver, with different time delays. This is illustrated in FIG. 11. As can be seen, due to the different times-of-arrival at the receiver, transient time intervals result, and a stable channel will occur for less than one complete symbol duration.

One result of performing a finite sample IDFT is that the resulting sampled time waveform of a symbol is cyclically continuous. If the sub-carriers of the next symbol are identically modulated, then its IDFT time samples will be identical to the first symbol, and will be connected to the first symbol without any time discontinuity. This property can be used to counter the multi-path transient by copying the tail end of a symbol's time samples and fixing it to the beginning of the symbol's time sample. In effect, the time duration taken for each symbol has been lengthened, but this allows the receiver to observe a complete symbol without any multi-path transient. This is shown in FIG. 12.

### SUMMARY OF THE INVENTION

An object of the present invention is to provide improved methods and apparatuses for GSM system capacity and spectrum efficiency.

In accordance with an aspect of the present invention there is provided a method of enhancing the capacity of a wireless communication channel compromising the steps of modulating data in accordance with first modulation scheme, to accommodate the voice data into GSM slots and signaling formats whereby capacity of the wireless communication channel is enhanced.

In accordance with another aspect of the present invention there is provided a system of enhancing the capacity of a wireless communication channel compromising the steps of modulating data in accordance with first modulation scheme, to accommodate the voice data into GSM slots and signaling formats whereby capacity of the wireless communication channel is enhanced.

In accordance with an aspect of the present invention there is provided a method of enhancing the capacity of a wireless communication channel compromising the steps of modulating data in accordance with first modulation scheme, transforming the modulated data from a frequency domain symbol to a time domain version and inserting bits in a wireless communication timeslot independence upon the time domain version whereby capacity of the wireless communication channel is enhanced.

In accordance with another aspect of the present invention there is provided a system for enhancing the capacity of a wireless communication channel comprising means for modulating data in accordance with first modulation scheme, means for transforming the modulated data from a frequency domain symbol to a time domain version and means for inserting bits in a wireless communication timeslot independence upon the time domain version whereby capacity of the wireless communication channel is enhanced.

In accordance with an aspect of the present invention there is provided a method of enhancing the capacity of a wireless communication channel compromising the steps of modulating data in accordance with first modulation scheme, forcing zeros where the spectrum intervals are not available, and transforming the modulated data from a frequency domain symbol to a time domain version whereby capacity of the wireless communication channel is enhanced.

In accordance with an aspect of the present invention there is provided a system of enhancing capacity a wireless communication channel compromising the steps of modulating data in accordance with first modulation scheme, stuffing zeros where the spectrum intervals are not available, and transforming the modulated data from a frequency domain symbol to a time domain version whereby capacity of the wireless communication channel is enhanced.

Conveniently, the system and method further comprises the steps of: means for receiving the sub-frame, means for decoding the sub-frame, and means for transforming the decoded bits from time domain to frequency domain to recover the data.

Advantageously, various embodiments enhance GSM capacity by two times and more than two times.

### BRIEF DESCRIPTION OF THE DRAWINGS

The present invention will be further understood from the following detailed description with reference to the drawings in which:

FIG. 1 illustrates a known GSM FDD-TDMA channel allocation;

FIG. 2 illustrates 5 typical GSM slot/burst types;

FIG. 3 illustrates GSM slot/frame numerology;

FIG. 4 illustrates GSM full rate speech coding process;

FIG. 5 illustrates how 20 ms voice coded bits are interleaved within 8 consecutive frames;

FIG. 6 illustrates the start and stop of a GSMK burst;

FIG. 7 illustrates 8-PSK modulation and gray mapping;

FIG. 8 illustrates the start and stop of each burst with 8-PSK modulation;

FIG. 9 illustrates an example of QPSK, 16-QAM and 64-QAM;

FIG. 10 illustrates the IDFT output in the time domain;

FIG. 11 illustrates a transmission and reception system for a multicarrier_symbol transmitted through a channel having multi-path;

FIG. 12 illustrates transmission and reception system for a multicarrier_symbol including a cyclic prefix transmitted through a channel having multi-path;

FIG. 13 illustrates QPSK modulation embedded in 8-PSK modulation in accordance with an embodiment of the present invention;

FIG. 14 illustrates the start and stop of a QPSK modulation burst in accordance with an embodiment of the present invention;

FIG. 15 illustrates how a full rate 20 ms speech coded bits are interleaved within 8 frames with QPSK modulation in accordance with an embodiment of the present invention;

FIG. 16 illustrates how legacy services are mixed with QPSK enabled services in accordance with an embodiment of the present invention; and

FIG. 17 illustrates how legacy services are mixed with QPSK enabled services and multicarier enabled services in accordance with an embodiment of the present invention.

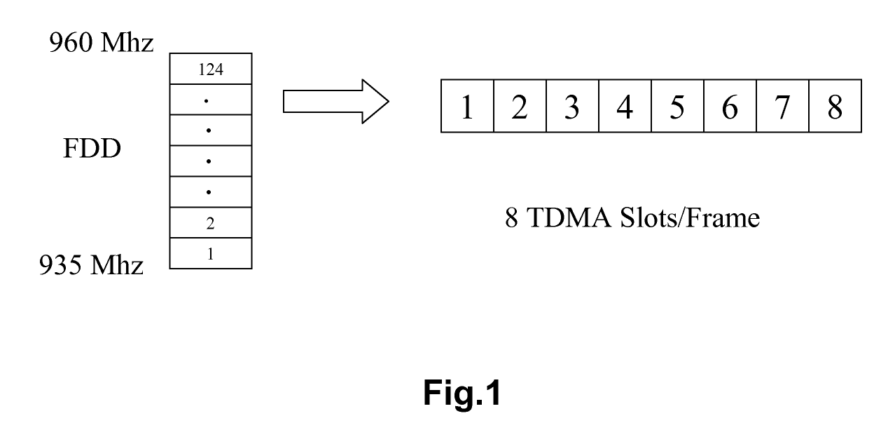

### DETAILED DESCRIPTION OF THE PREFERRED EMBODIMENT

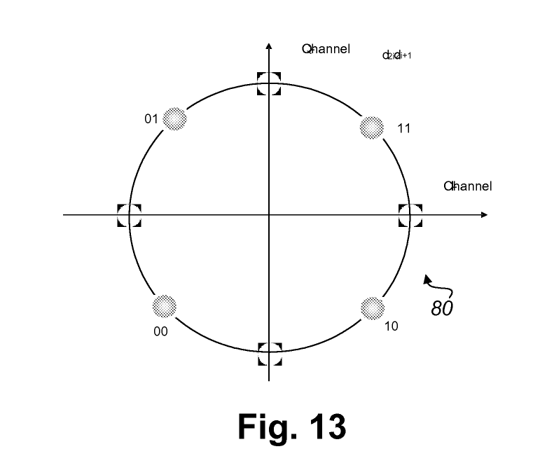

Referring to FIG. 13 there is illustrated symbol mapping of modulating bits into QPSK symbols for transmission in a GSM data field in accordance with an embodiment of the present invention

In accordance with a first embodiment of the present invention, doubling of the voice traffic capacity of GSM can be achieved, using the QPSK extracted from 8-PSK modulation. For voice traffic in standard GSM, both data fields of a timeslot are GMSK modulated. If instead, the data fields are QPSK modulated, one voice signal can be accommodated in one data field of the assigned timeslots and another voice signal can be accommodated in the second data field.

Because QPSK is a subset of 8-PSK, minimal software change is needed for both the base station and the terminal.

To communicate with a base station employing this QPSK modulated voice signal, a new class of remote terminals (hand sets) must be realized with the capability to demodulate QPSK. As with the base station, the only change in the terminal from a standard GSM terminal is some software to demodulate the QPSK signal from the appropriate data fields in the assigned timeslots, and to modulate the return-path signal as QPSK in the appropriate data fields in the assigned timeslots.

The modulating bits are Gray mapped in groups of two to QPSK symbols by the rule

sᵢ=e^{j2πl/8}

where l is given in the following table and is shown in FIG. 13.

| Modulating bits d₂ᵢ,, d₂ᵢ₊₁ | Symbol parameter l |
|---|---|
| (0, 0) | 3 |
| (0, 1) | 1 |
| (1, 0) | 5 |
| (1, 1) | 7 |

Symbol Rotation: The QPSK symbols are continuously rotated with 3π/8 radians per symbol before undergoing linearized GMSK pulse shaping. The rotated symbols are defined as

ŝᵢ=sᵢ·e^{ji3π/8}

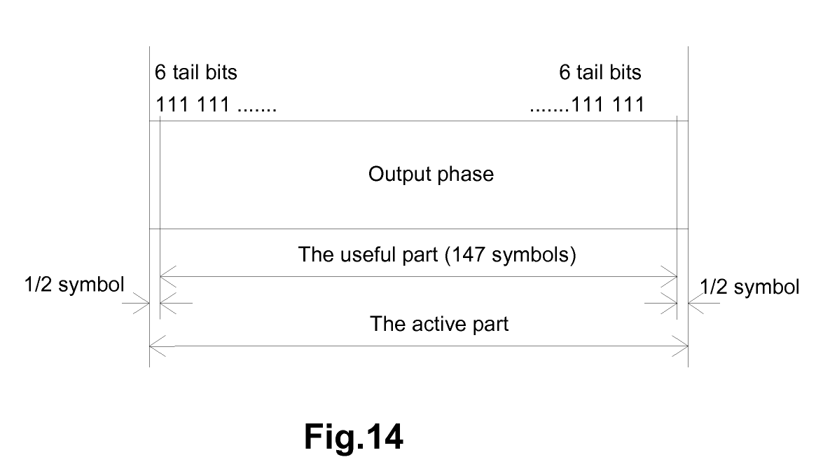

For a normal burst, the bit field is illustrated in the following table and FIG. 14.

| | Length of field | |
|---|---|---|
| Bit Number (BN) | (bits) | Contents of field |
| 0–5 | 6 | tail bits |
| 6–121 | 116 | encrypted bits (e0.e115) |
| 122–173 | 52 | training sequence bits |
| 174–289 | 116 | encrypted bits (e116. |
| | | e231) |
| 290–295 | 6 | tail bits |
| 296–312.5 | 16.5 | guard period |

The “tail bits” are defined as modulating bits with states as follows (bits are grouped in symbols separated by;):
(BN0, BN1 . . . BN5)=(1,1;1,1;1,1) and
(BN290, BN291 . . . BN295)=(1,1;1,1;1,1)
   Here the “training sequence bits” are defined as modulating bits with states to be determined according to the training sequence code, TSC.

Interleaving and Mapping on a Burst

The channel encoded bits c(n,k), where k=0, 1, 2, . . . , 455 is the bit index within a voice block and n=0, 1, 2, . . . , N, N+1, . . . , is the voice block index, are reordered and interleaved according to the following rule:

i(B,j)=c(n,k), for k=0, 1, . . . , 455
n=0, 1, . . . , N, N+1, . . .
B=B0+2n+(k mod 4)
j=2((49k) mod 57)+((k mod 4) div 2)
   where B is the burst/block index and j is the bit index within burst B. Each QPSK burst B contains 228 bits. So the encoded bit c(n,k) is mapped to i(B,j) after interleaving.
   The result of the interleaving is a distribution of the reordered 456 bits of a given data block, n=N, over 4 bursts using the even numbered bits of the first 2 blocks (B=B₀+2N+0, 1) and odd numbered bits of the last 2 blocks (B=B₀+2N+2, 3). The reordered bits of the following data block, n=N+1, use the even numbered bits of the blocks B=B₀+2N+2,3 (B=B₀+2(N+1)+0, 1) and the odd numbered bits of the blocks B=B₀+2(N+1)+2,3. Continuing with the next data blocks shows that one block always carries 114 bits of data from one data block (n=N) and 114 bits of data from the next block (n=N+1), where the bits from the data block with the higher number always are the even numbered data bits, and those of the data block with the lower number are the odd numbered bits. The block of coded data is interleaved “block diagonal”, where a new data block starts every second block and is distributed over four blocks.

Mapping on a Burst

The interleave bits are mapped to a QPSK burst according to the rule:
e(B,j)=i(B,j) and e(B,j+118) for j=0, 1, . . . , 113
and
e(B,114)=e(B,115)=hl(B) and e(B,116)=e(B,117)=hu(B)
The two bits, labelled hl(B) and hu(B) on burst number B are flags used for indication of control channel signalling.

FACCH Support in QPSK TCH/FS

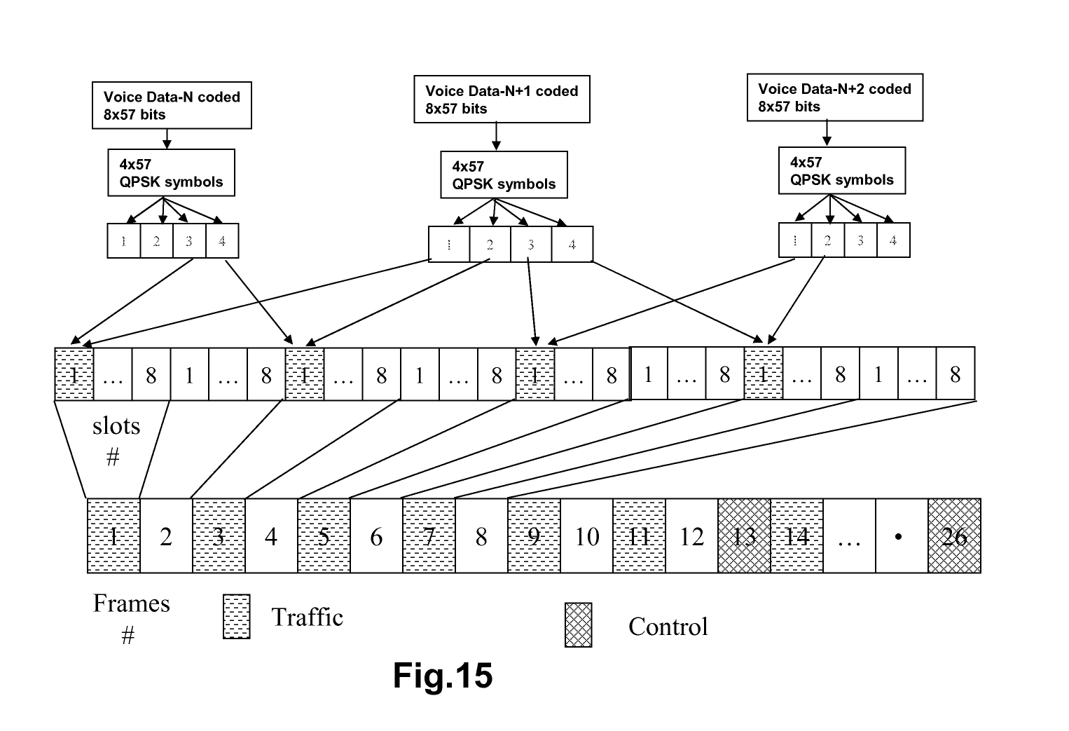

A QPSK FACCH/F frame of 456 coded bits is mapped onto four QPSK bursts as specified in FIG. 15 for the QPSK TCH/FS.
A QPSK FACCH is transmitted on bits which are stolen from a burst in the traffic channel, the even numbered bits in the first two QPSK bursts and the odd numbered bits of the last two QPSK bursts are stolen.
To indicate this to the receiving device, the flags hl(B) and hu(B) have to be set according to the following rule:
hu(B)=1 for the first two bursts (even numbered bits are stolen bits);
hl(B)=1 for the last two bursts (odd numbered bits are stolen bits).
For each QPSK TCH/FS block not stolen for signalling purposes:
hu(B)=0 for the first two bursts (indicating status of even numbered bits)
hl(B)=0 for the last two bursts (indicating status of odd numbered bits)

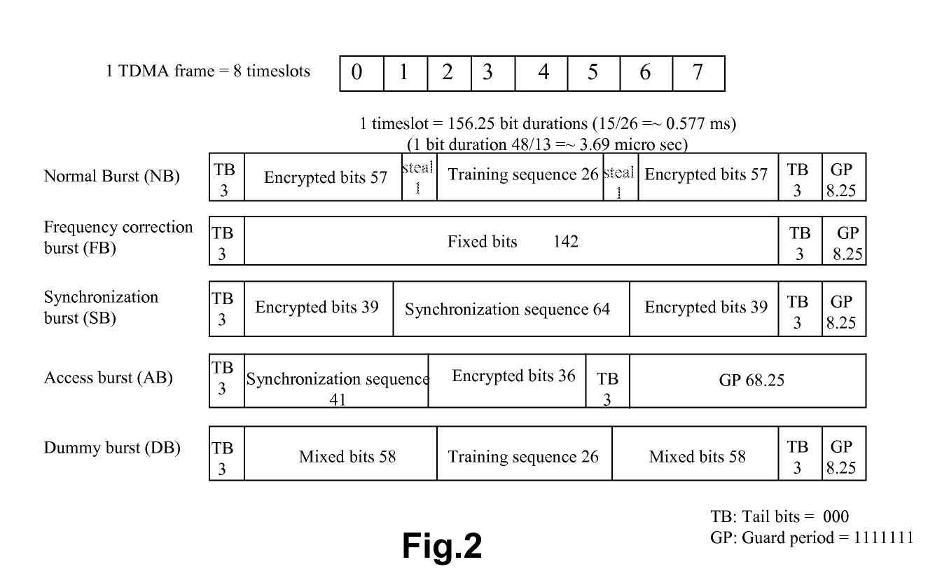

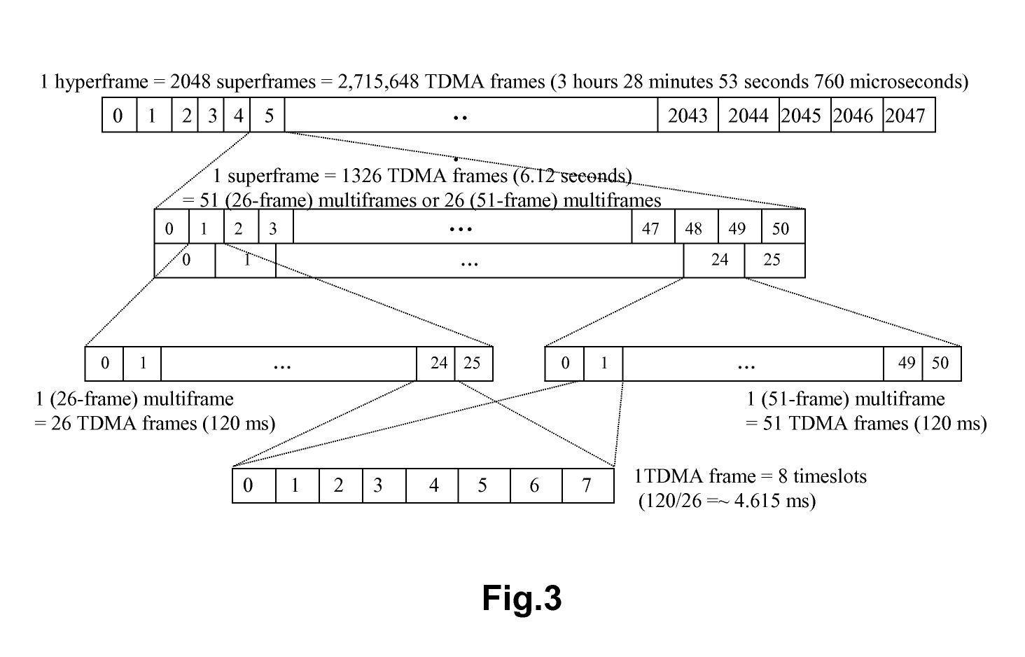

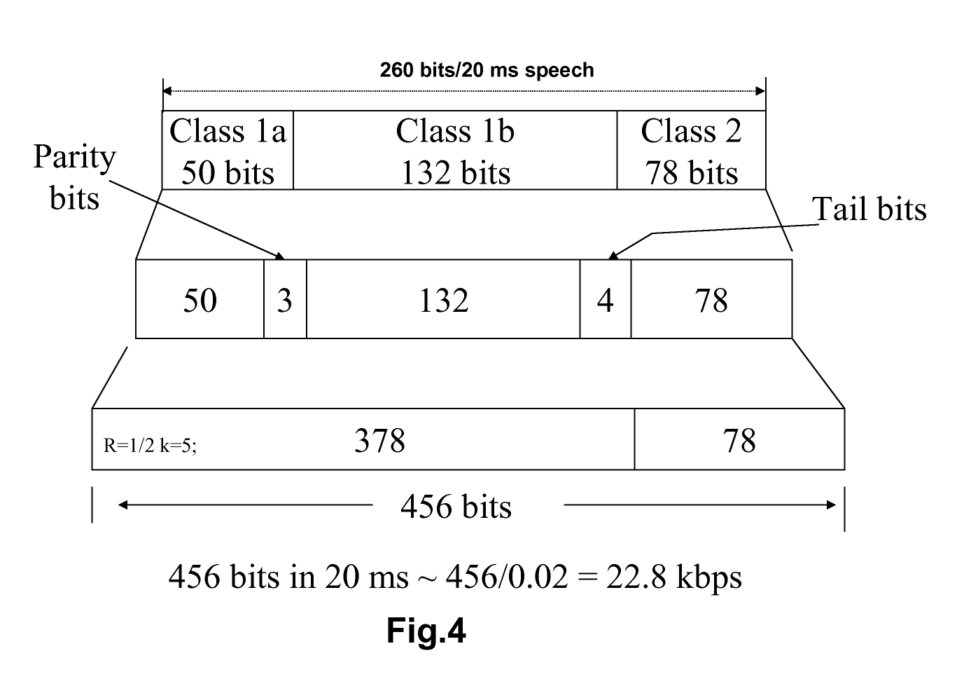

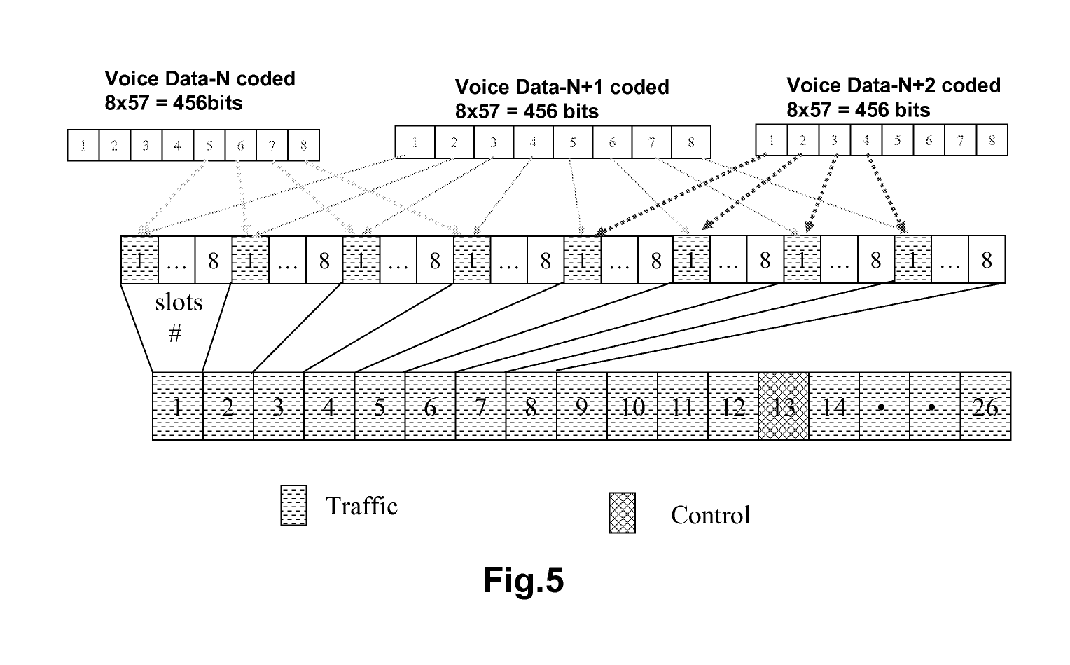

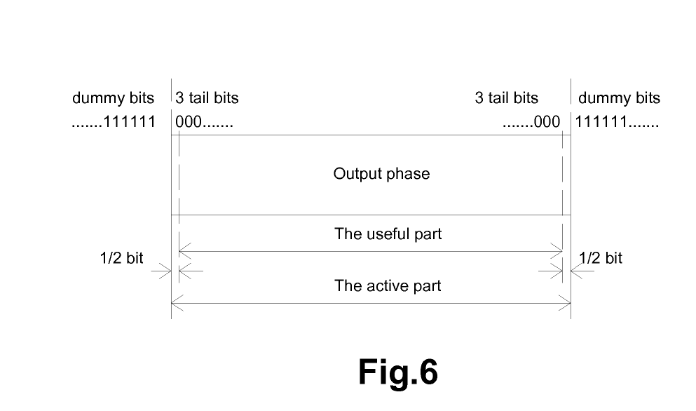

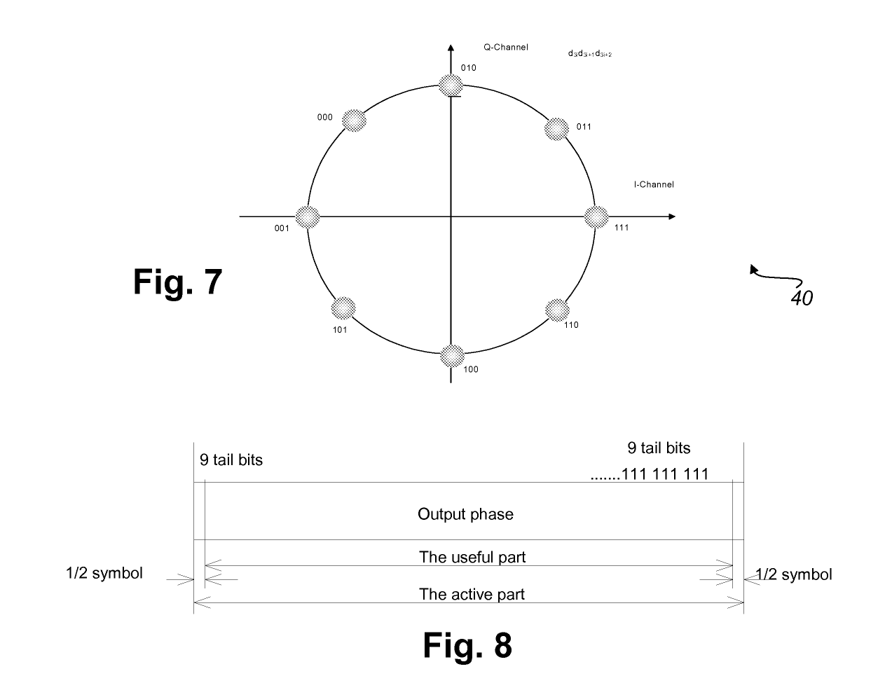

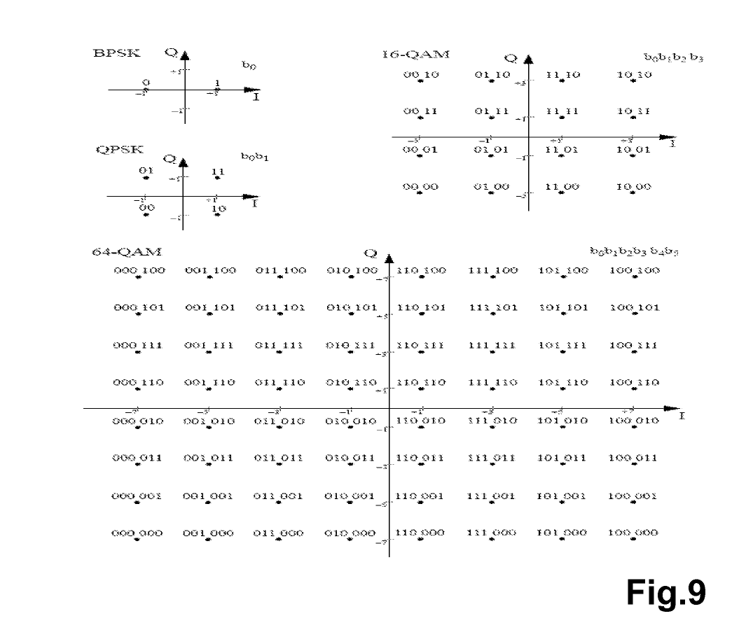

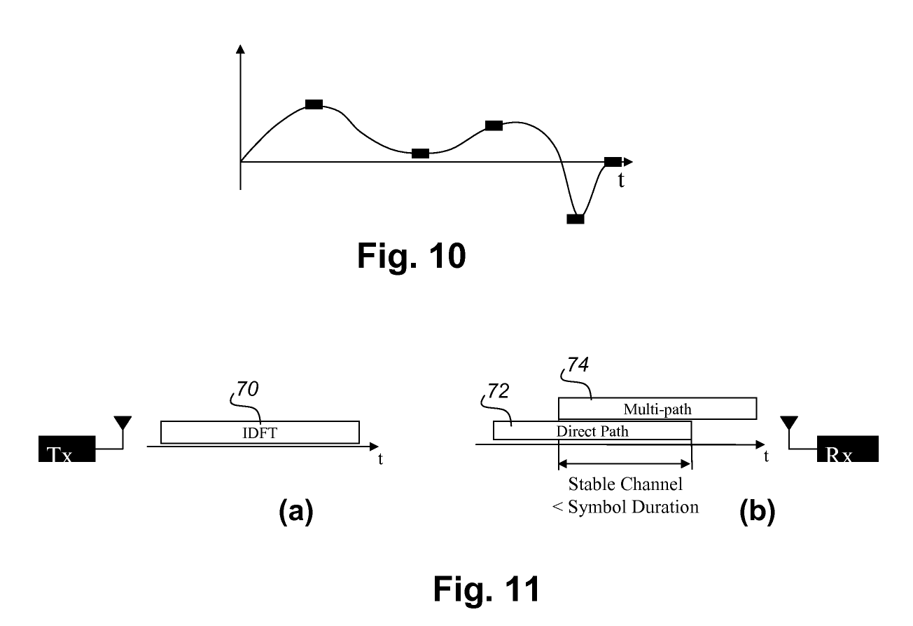

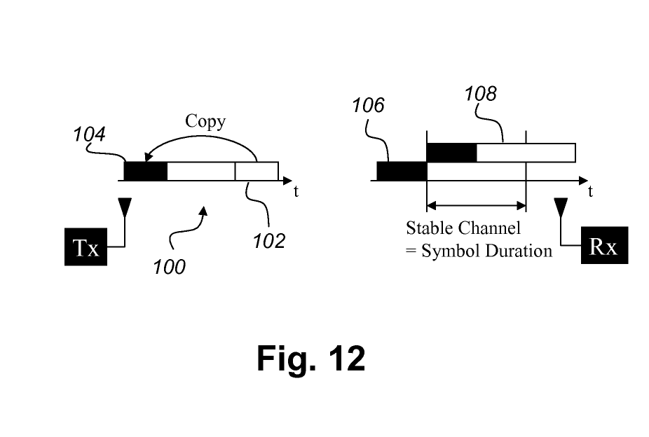

A further improvement in throughput rate is possible with Multicarrier Modulation embedded within the timeslot structure. Each of the two data fields in a GSM timeslot can provide 57 time-samples for a Multicarrier symbol, in place of 57 GMSK modulated bits. Assuming five time-samples are required to cover the multipath delay spread, then there remains 52 time-samples available for a Multicarrier_symbol. This is shown in FIG. 2. With each of 52 sub-carriers modulated with 64 QAM, an improvement in data throughput rate compared with GMSK is 6×(52/57), a factor of 5.5.

Advanced Multicarriers in a GSM Sub-Frame A further improvement to a factor of 6.0 can be achieved by using all 57 time-samples for the Multicarrier symbol. Here use is made of the knowledge of the five tap coefficients c₀, c₁, c₂, c₃, c₄ of the multipath channel, of the known 3 leading tail bit and the 3 trailing tail bit “zeros” in the GSM time slot, and of the known 26 timing bits.

Let the 57 transmitted time-samples (data field) be a₀, a₁, a₂, . . . a₅₆. The received time-samples zᵢ are then:

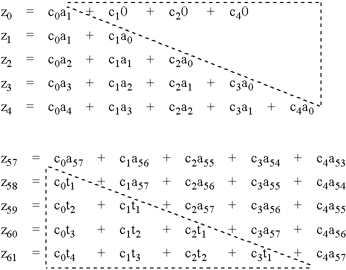

Now since the leading time-samples are all 0 and the timing bits tᵢ are known, the transmitted time-samples a₀, a₁, a₂, . . . a₅₆ can be determined. A computationally efficient manner to do this is first to determine a₅₄ through a₅₇ using the last four equations above, and add the following to the measured z₀ through z₃ as shown.

$$\begin{matrix}{z}_{0}^{′} = {z}_{0} + {c}_{1} {a}_{57} + {c}_{2} {a}_{56} + {c}_{3} {a}_{55} + {c}_{4} {a}_{54} \\ = {c}_{0} {a}_{0} + {c}_{1} {a}_{57} + {c}_{2} {a}_{56} + {c}_{3} {a}_{55} + {c}_{4} {a}_{54}\end{matrix}$$

$$\begin{matrix}{z}_{1}^{′} = {z}_{1} + {c}_{2} {a}_{57} + {c}_{3} {a}_{56} + {c}_{4} {a}_{55} \\ = {c}_{0} {a}_{1} + {c}_{1} {a}_{0} + {c}_{2} {a}_{57} + {c}_{3} {a}_{56} + {c}_{4} {a}_{55}\end{matrix}$$

$$\begin{matrix}{z}_{2}^{′} = {z}_{2} + {c}_{3} {a}_{57} + {c}_{4} {a}_{56} \\ = {c}_{0} {a}_{2} + {c}_{1} {a}_{1} + {c}_{2} {a}_{0} + {c}_{3} {a}_{57} + {c}_{4} {a}_{56}\end{matrix}$$

$$\begin{matrix}{z}_{3}^{′} = {z}_{3} + {c}_{4} {a}_{57} \\ = {c}_{0} {a}_{3} + {c}_{1} {a}_{2} + {c}_{2} {a}_{1} + {c}_{3} {a}_{0} + {c}_{4} {a}_{57}\end{matrix}$$

Then the following set of equations can be substituted for the previously received time-samples.

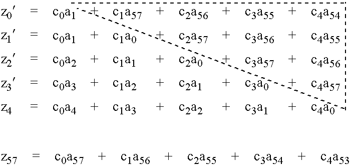

These equations represent a cyclic convolution between the transmitted time-samples and the channel coefficients.

Z=c\textcircled{X}a

Taking the Digital Fourier Transform yields:

DFT[z]ᵢ=DFT[c]ᵢDFT[a]ᵢ

As a result, the transmitted QAM modulated sub-carriers are recovered as:

DFT[a]ᵢ=DFT[z]ᵢ/DFT[c]ᵢ

Multicarrier using the Guard Bits from the previous GSM Time Slot as a Cyclic Prefix As shown in FIG. 2, each GSM normal burst ends with a string of 8.25 ones. As a result, the string of ones at the end of a previous time slot can be considered as an identical cyclic prefix of a Multicarrier_symbol consisting of all time samples in the subsequent time slot (3 tail bits, 58 first data field bits, 26 timing bits, 58 second data field bits, 3 tail bits, and 8 of the 8.25 trailing zero bits. With this interpretation, a Multicarrier_symbol having 156 sub-carriers can be fit into the GSM time slot, albeit with constraints that the 26 bits during the timing portion of the time slot must have specified values, the 6 tail bits must be zero, and the 8 guard bits must be one.

The Inverse Digital Fourier Transform (IDFT) is given by:

$$x [ n ] = {\sum }_{k = 0}^{N - 1} X [ k ] exp ( j k [ 2 π / N ] n ) , n = 0 , 1 , 2 , … N - 1$$

Normally, for a 156 sub-carrier Multicarrier_symbol, all frequency domain values of X[k] are known, and all time domain values of x[n] are calculated. However, in this scenario, 40 time domain values are pre-specified (the 26 timing, 6 tail, and 8 guard bits). In order to satisfy the IDFT equations, this requires 40 of the frequency domain sub-carriers to be left as variables, while data is assigned to the remaining 156−40=116 sub-carriers.

The system of equations can then be solved to fill in the unspecified sub-carrier values and to then compute the time domain sequence.

Increased Throughput Rate for the Up Link (Terminal to Base-Station) and for the Down Link (Base-Station to Terminal) The “Advanced Multicarrier_in a GSM Sub-Frame” technique does not add any computational load for the transmitter, but adds computational load to the receiver. This arises since the trailing time-samples of the symbol must first be determined and the initial received time-samples adjusted, before the Digital Fourier Transform and matrix division can be performed to provide the sub-carrier QAM values.

Similarly, the “Multicarrier_using the Guard Bits from the previous GSM Time Slot as a Cyclic Prefix” technique adds computational load to the transmitter, but does not add any computational load to the receiver. This arises since the unspecified sub-carriers must first be determined, before the Inverse Digital Fourier Transform can be performed to provide the time domain sequence.

Since it is not desirable to add any computational load to a terminal, but it is acceptable to do so for a base-station, the “Advanced Multicarrier_in a GSM Sub-Frame” technique can be used for the Up Link (Terminal to Base-Station), and the “Multicarrier_using the Initial Zeros of a GSM Sub-Frame as a Cyclic Prefix” technique can be used for the Down Link (Base-Station to Terminal), to increase the throughput rate in both directions.

Controlled Migration to double the GSM voice capacity. While some frequency channels, frames, or timeslots can be allocated for the enhanced voice capacity, the remaining frequency channels, frames, and timeslots can carry traditional, legacy GSM traffic.

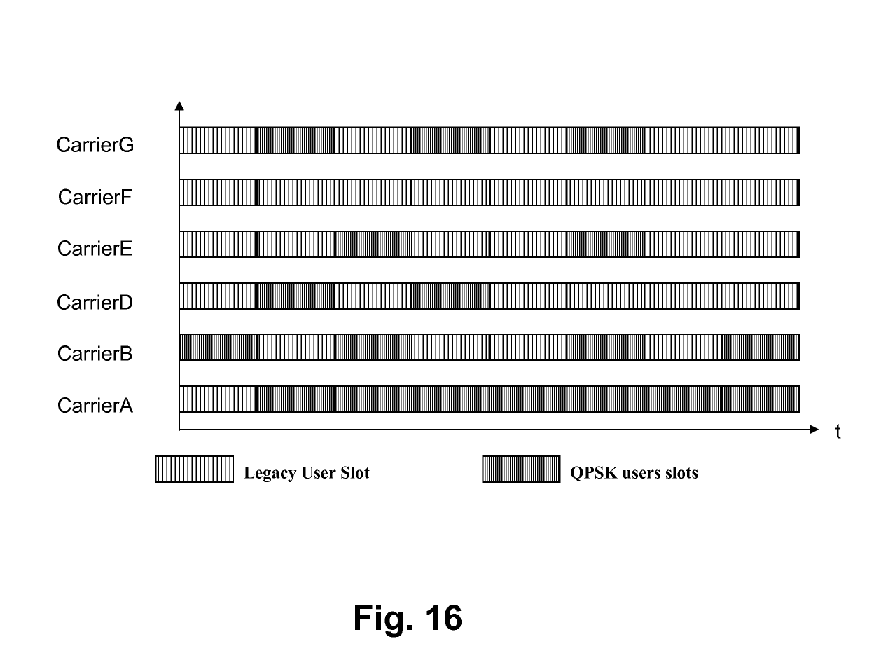

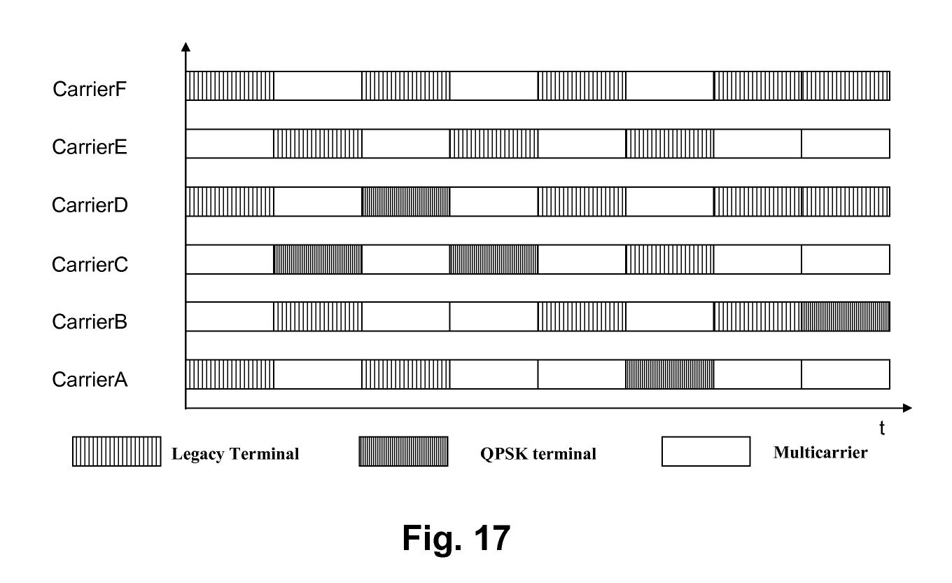

Controlled Migration to Increased GSM Network Throughput. For all three methods for increasing the throughput rate for a GSM base station, a controlled migration can be achieved through the use of two QPSK modulation to double the voice channel capacity or the use of Multicarrier modulation in the data fields of a sub-frame, as illustrated in FIGS. 16 and 17.

In FIG. 16, the migration takes the form of:
Keep Legacy terminals working as is.
One QPSK slot serves two voice users

In FIG. 17, the migration scheme is:
Continue to serve legacy terminals
Use QPSK capable terminals to release more spectrum
Serve multicarrier capable terminals High Data rate

While some frequency channels, frames, or timeslots can be allocated for the enhanced throughput rate schemes, the remaining frequency channels, frames, and sub-frames can carry traditional, legacy GSM traffic.

Numerous modifications, variations and adaptations may be made to the particular embodiments described above without departing from the scope patent disclosure, which is defined in the claims.

What is claimed is:

1. A method of enhancing capacity of a wireless communication channel compromising the steps of
modulating data in accordance with first modulation scheme; and
encoding bits in a wireless communication timeslot intended for a second modulation scheme using the first modulation scheme;
whereby capacity of the wireless communication channel is enhanced.

2. A method as claimed in claim 1 wherein the communication timeslot is a global system for mobile communication (GSM) timeslot burst.

3. A method as claimed in claim 2 wherein the first modulation scheme is quadrature phase-shift keying (QPSK).

4. A method as claim in 3 wherein the QPSK modulated data goes through a linearized GMSK filter

5. A method as claimed in claim 3 wherein each timeslot data field carries two times greater voice bits compared to GMSK

6. A method as claimed in 4 wherein every 20 ms full rate speech coded bits are divided into four consecutive QPSK symbol blocks, which are interleaved within eight consecutive GSM frames.

7. A method to enable a QPSK FACCH comprising the steps of:
transmitting on bits which are stolen from a burst in the traffic channel, the even numbered bits in the first two QPSK bursts and the odd numbered bits of the last two QPSK bursts being stolen.

8. A method as claimed in claim 7 wherein the transmitting is indicated to the receiving device the flags hl(B) and hu(B) have to be set according to the following:
hu(B)=1 for the first two bursts (even numbered bits are stolen bits);
hl(B)=1 for the last two bursts (odd numbered bits are stolen bits);
For each QPSK TCH/FS block having no stolen bits:
hu(B)=0 for the first 2 bursts (indicating status of even numbered bits)
hl(B)=0 for the last 2 bursts (indicating status of odd numbered bits).

9. A method as claimed in claim 3 wherein the voice traffic capacity is enhanced about two times.

10. A method of enhancing capacity of a wireless communication channel compromising the steps of
modulating data in accordance with first modulation scheme;
transforming the modulated data from a frequency domain symbol to a time domain version; and
encoding bits in a wireless communication timeslot independence upon the time domain version;
whereby capacity of the wireless communication channel is enhanced.

11. A method as claimed in claim 10 wherein data is modulated using multicarrier modulation.

12. A method as claimed in claim 11 wherein each data timeslot carries one multicarrier symbol.

13. A method as claimed in claim 11 wherein the multicarrier_symbol uses a subset of the timeslot.

14. A method as claimed in claim 11 wherein the capacity is enhanced about 5.5 times.

15. A method as claimed in claim 11 wherein the multicarrier_symbol uses the whole timeslot.

16. A method as claimed in 15 wherein a multicarrier slot can coexists with a GMSK modulated slot.

17. A method as claimed in claim 7 wherein the capacity is enhanced about 6 times.

18. A method as claimed in claim 10 further comprising the steps of:
receiving the time slot;
decoding the time slot; and
transforming the decoded bits from time domain to frequency domain to recover the data.

19. A system for enhancing capacity of a wireless communication channel compromising the steps of
means for modulating data in accordance with first modulation scheme; and
means for encoding bits in a wireless communication timeslot intended for a second modulation scheme using the first modulation scheme;
whereby capacity of the wireless communication channel is enhanced.

20. A system as claimed in claim 19 wherein the communication sub-frame is in a global system for mobile communication (GSM) timeslot burst.

21. A system as claimed in claim 20 wherein data is modulated using quadrature phase-shift keying (QPSK) extracted from 8-PSK.

22. A system as claimed in claim 21 wherein each timeslot carries 2 times voice bits.

23. A system as claimed in claim 21 wherein the voice traffic capacity is enhance about two times.

24. A system for enhancing capacity of a wireless communication channel compromising the steps of
means for modulating data in accordance with first modulation scheme;
means for transforming the modulated data from a frequency domain symbol to a time domain version; and
means for encoding bits in a wireless communication sub-frame independence upon the time domain version;
whereby capacity of the wireless communication channel is enhanced.

25. A system as claimed in claim 24 wherein data is modulated using multicarrier modulation.

26. A system as claimed in claim 25 wherein each data timeslot carries one multicarrier symbol.

27. A system as claimed in claim 25 wherein the multicarrier_symbol uses a subset of the timeslot bits.

28. A system as claimed in claim 25 wherein the capacity is enhanced about 5.5 times.

29. A system as claimed in claim 20 wherein the multicarrier_symbol uses all of the timeslot bits.

30. A system as claimed in claim 25 wherein the capacity is enhanced about 6 times.

31. A system as claimed in claim 25 further comprising the steps of:
means for receiving the timeslot;
means for decoding the timeslot; and
means for transforming the decoded bits from time domain to frequency domain to recover the data.

32. A method as claimed in claim 3 including the step of using guard bits from a previous GSM time slot as a cyclic prefix.

33. A method as claimed in claim 6 wherein the multicarrier_symbol uses a subset of the timeslot bits in a downlink and the multicarrier_symbol uses all of the timeslot bits in an uplink.

34. A method of migration to increase base station throughput comprising applying the method of claim 1 to a first subset of timeslots.

35. A method as claimed in claim 28 further comprising applying the method of claim 6 to a second subset of timeslots.

36. A system as claimed in claim 14 including means for using guard bits from a previous GSM timeslot as a cyclic prefix.

37. A system as claimed in claim 19 wherein the multicarrier_symbol uses a subset of the timeslot in a downlink and the multicarrier_symbol uses all of the timeslot bits in an uplink.
